(19) United States
(12) Patent Application Publication
(10) Pub. No.: US 2013/0006401 A1
(43) Pub. Date: Jan. 3, 2013

(54) NETWORKED INTELLIGENT PLANT GROWTH SYSTEM

(76) Inventor: Xinxin Shan, Surrey (CA)

(21) Appl. No.: 13/229,464

(22) Filed: Sep. 9, 2011

Related U.S. Application Data
(60) Provisional application No. 61/503,443, filed on Jun. 30, 2011.

(51) Int. Cl. G06F 17/00

(52) U.S. Cl. 700/90

(57) ABSTRACT

A plant growth system for growing one or more plants in a computer controlled environment, the computer controlling the environment according to a formula. The system is connected to a data exchange and communication center over the internet for sharing and distribution of formulas for controlling plant growth in the system.

### CROSS-REFERENCE TO RELATED APPLICATIONS

This application claims the benefit under 35 U.S.C. §119(e) of U.S. Provisional Application Ser. No. 61/503,443, filed Jun. 30, 2011.

### TECHNICAL FIELD

The present document is related in particular to a networked plant growth system that may use LED (light emitting diode) as the lighting sources.

### BACKGROUND

Traditional plant growth systems were designed to work independently and they depended extensively upon persons who were very skilled in plant growth. These persons and organizations were limited by their own experiences and expertise. Ordinary person possessing limited horticultural knowledge were usually unable to use these systems. It takes a long time to create a formula for a specific plant's optimum growing conditions. Some existing plant growth systems with only a few preset manufactured programs are unable to provide sufficient formulas for all of the various demands upon the market.

Traditional plant growth systems have used various lighting sources such as incandescent lighting, fluorescent lighting, high pressure sodium (following called HPS) lights, and metal halide (following called MH) lamps as the complementary lighting source. Varied plant growth needs different color spectrum(s) (following called color(s)) and different intensities at the different growing stages. Traditional lighting sources cannot provide high efficiency, high intensity lighting colors according to the individual needs of varied plant growth. The high amounts of heat produced by HPS and MH lights are also a serious problem for optimal plant growth. As a new generation of highly efficient lighting sources, LED can provide the exact light color with the appropriately designed light intensities for a variety of plants at different growing stages.

### SUMMARY

There is provided a disclosure of a networked intelligent plant growth system that includes one or more terminals, and one or more data exchange and communication centers. The terminals are connected to the data exchange and communication center through a network. Each terminal includes the following: a controller, a LED lighting system, sensor system, data storage and sharing system, and other conditioning subsystems. The system uses LED for its lighting purposes. The light intensity, light color(s) are all adjustable for the needs of a variety of plants. The sensor system collects environmental and plant growing information such as the light intensity, the CO2 levels, the leaf color, and the ambient temperature etc. The controller adjusts the LED light radiation and the other conditioning subsystems based upon the collected information and/or the present plant growing data. This collected information and growing data may be stored and shared throughout the data sharing system. Also, growing data may be acquired from other terminals or the data exchange and communication center throughout the data sharing system either in a point-to-point method or via a server. A control system may then be set up according to this data. The centralized server, data exchange and communication center is responsible for storing the data, and sharing the data to the system users or the public through Internet or Ethernet. Thus, the system may provide a means to crowdsource plant growing formulas.

A plant growth system is disclosed, the system having a terminal comprising: a zone for growing a plant; a sensor system in the zone connected to detect one or more conditions in the zone; a conditioning system in the zone connected to alter one or more conditions in the zone; a control system connected to the sensor system and the conditioning system for controlling the conditioning system according to information from the sensor system and a condition formula that is one or both of developed with the terminal or received from a data exchange and communication center; the control system being connected to receive the condition formula from the data exchange and communication center, and send the condition formula and information from the sensor system to the data exchange and communication center.

A plant growth system is also disclosed for connecting to a data exchange and communication center, the plant growth system comprising: a location for growing a plant, the location having conditions for growing the plant; a sensor system in the location for growing the plant for detecting the conditions in the location for growing the plant; a function system in the location for growing the plant for controlling the conditions in the location for growing the plant; a control system being configured to connect to the data exchange and communication center for receiving a formula from the data exchange and communication center and for sending information collected by the sensor system to the data exchange and communication center; and the control system being connected to the sensor system and to the function system for controlling the function system according to input from the sensor system and according to the formula.

A plant growth system is also disclosed comprised of: an LED lighting system that includes controllable single or mixed colors and intensities; a programmable and recordable controller; a data storage and data sharing systems; a data exchange and communication center that may download and/or upload the plant's growth and related data. All or selected data of a plant's growth may be shared with other terminals in a point-to-point method or through a data exchange and communication center.

In various embodiments, there may be included any one or more of the following features: The conditioning system further comprises an LED lighting system that includes LEDs and is adjustable in color and intensity. The LEDs are configured to produce one or both of visible and invisible light. The LED lighting system is configured to produce one or both of single or mixed colors. The conditioning system further comprises one or more of a dimmable or non-dimmable metal halide light, a high pressure sodium light, a low pressure sodium light, a fluorescent light, an incandescent light, and a plasma light with single or mixed colors. The control system is programmable and includes a data storage system. The one or more conditions alterable by the condition system comprise one or more of light intensity, light color, lighting time period, humidity, temperature, CO2 concentration, and fertilization. A plurality of terminals are connected through one or more telecommunication networks to the data exchange and communication center. The terminal is connected to communicate with other terminals of the plurality of terminals through the data exchange and communication center or through one or more telecommunication networks by a point to point method. The control system is connected to selectively receive the condition formula from a plurality of condition formulas stored with the data exchange and communication center. The data exchange and communication center is accessible by the public through one or more telecommunication networks. The information includes one or more of light color, light intensity, control system action, sensor measurement, environment conditions, fertilization adjustment, analysis results done by the control system, date and time, equipment, organization, information associated with plant growth, and identification of the terminal. The terminal is locally or remotely accessible by a terminal user through one or more of a wired connection, a wireless connection, or one or more telecommunication networks. The control system further comprises a touch screen user interface. The sensor system further comprises one or more cameras to monitor plant growth. The zone comprises one or more of a chamber, a cabinet, a shelf, a shelter, a house, a building, an underground haven, a soil growing medium, a non soil growing medium, an aquarium, and a greenhouse. The plant growth system is applied as a mini-plant growing system. The plant growth system is applied in private, commercial, or industrial plant growth. The plant growth system comprises the data exchange and communication center. The data exchange and communication center comprises two or more data exchange and communication centers. The terminal has a USB port to input and output data. The terminal further comprises one or more power sources. The one or more power sources comprises one or more of a wall plug, or electrical power generated from coal, fuel, hydro, wind turbine, tidal power, or a solar panel. The plant growth system of claim is one that controls one or more functions such as light intensity, light color, lighting time period, humidity, temperature, and fertilization. The plant growth system is one in which the data exchange and communication system is open to the public. The plant growth system is one in which the terminal may communicate with one or plural terminals in the system through the data exchange and communication center. The plant growth system is one in which the data may be involved in all or selected information of light colors, light intensity, controller action, sensor measurement, environment conditions, fertilization adjustment, analysis results done by the controller of the terminal, date and time, equipment, organization, identification of the terminals and other related activities. The plant growth system is also comprised of one or plural sensor systems that collect information regarding the plant's growth and the environmental conditions. The plant growth system contains a lighting system in which the LED color(s) may be visible or invisible. The plant growth system possesses a controller, a data storage system, and a data sharing system that may be locally or remotely accessed. The plant growth system has a controller, a data storage system, and a data sharing system that may control a group of functions. The plant growth system has a control system that may control the function systems through a wire or do so wirelessly. The plant growth system has a controller, a data storage system, and a data sharing system with a touch screen as the user interface. The plant growth system possesses a data sharing system and a communication center that is networked. The plant growth system is comprised of one or plural temperature control systems. The plant growth system contains one or plural humidity control systems. The plant growth system contains one or plural fertilizing systems. The plant growth system contains one or plural watering systems. The plant growth system contains one or plural camera monitors to monitor the plant's growth. The plant growth system has a USB port to input/output data. The plant growth system is comprised of one or plural power sources which may include a wall plug, electrical power generated from coal, fuel, hydro, wind turbine, tidal power, or a solar panel. The plant growth system may be applied in a chamber, cabinet, shelf, shelter, house, building, underground haven, and a greenhouse. The plant growth system may be applied in mini-plant growing systems. The plant growth system may be applied in conditions of soil and non soil and grow solution. The plant growth system may be applied in aquarium systems in which water-dwelling plants or animals grow. The plant growth system may be applied in private, commercial, and industrial plant growth. The plant growth system is one in which the LED lighting system may be replaced with dimmable or non-dimmable metal halide lights, high pressure sodium lights, low pressure sodium lights fluorescent lights, incandescent lights and plasma lights with single or mixed colors.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 shows the main structure of the plant growth system including one terminal system and one data exchange and communication center; and

FIG. 2 shows the network structure of plural terminals and the data exchange and communication centers.

### DETAILED DESCRIPTION

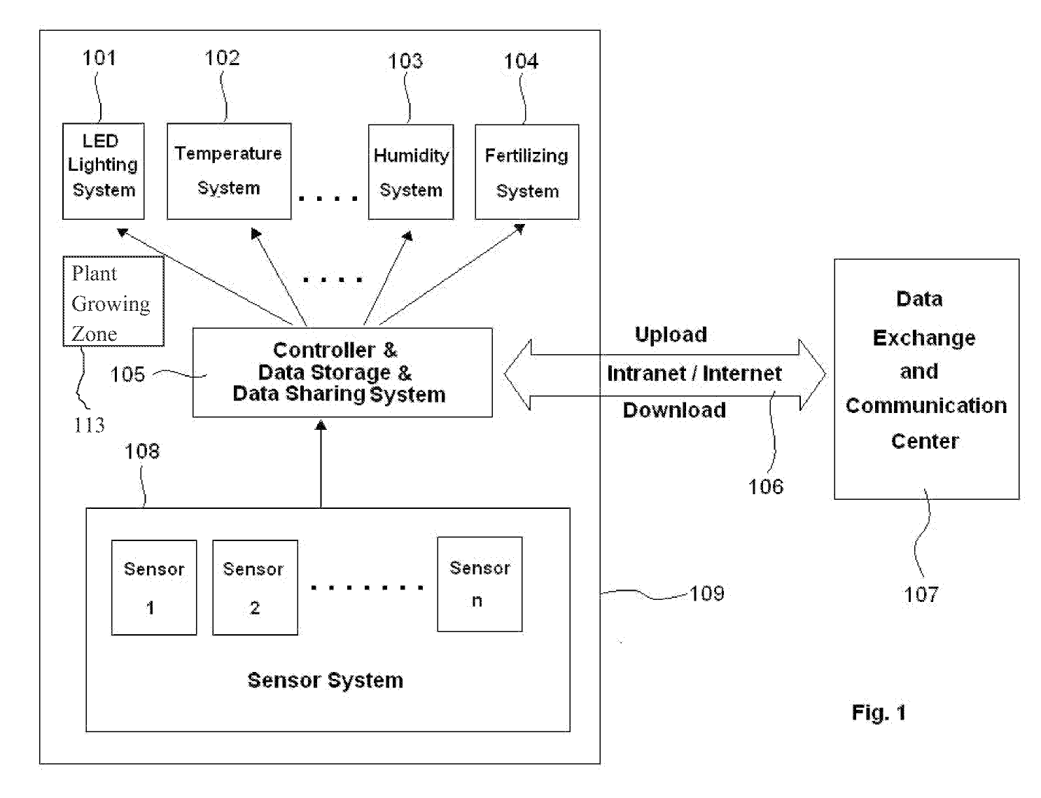

FIG. 1 shows the structure of a plant growth system including a terminal 109 connecting to a data exchange and communication center 107 for example through one or more networks 106. The terminal 109 includes a zone 113 for growing a plant and a control system 105 for example having a data storage and data sharing system 105, and being programmable. Terminal 109 also includes a sensor system 108 connected to detect one or more conditions in the zone 113, and a conditioning system, for example having plural conditioning subsystems 101, 102, 103 and 104, which may include, but are not limited to, an LED lighting system 101, a temperature system 102, a humidity system 103, and a fertilizing system 104. Other conditioning subsystems may be provided to alter one or more conditions such as light intensity, light color, lighting time period, and CO₂ concentration. In general the conditioning system is connected to alter one or more conditions in the zone 113. The network 106 may be an intranet system or an internet system or a 3G network or another type of network system.

The LED lighting system 101 may include LEDs and is adjustable in color and intensity. For example, the system 101 includes one or several colors of red, green, blue, yellow, infra-red, and ultraviolet. Different colors may be combined proportionally. The light intensity of each color may be adjustable according to the needs of plant growth at different growing stages. In some cases individual LEDs are adjustable in color. The LED lighting system 101 may have different shapes such as bulbs, linear, and panel. The LEDs may be configured to produce one or both of visible and invisible light. The LEDs with different colors may be integrated in one lamp to provide combined spectrums, or they may be built separately with a single color and then the user may use a different number of LED lamps with different colors to control the proportion of the colors. All of these lamps may be controlled by the controller 105. The features that may be controlled include the light intensity and the lighting time of each color. These lamps may be installed several inches away from the plant depending upon the plant species and the growing needs at different growing stages. One of the benefits of installing the lamps close to the plant is to save more energy because the light energy will not be wasted during the transmission. The lamp's position may be adjusted during the plant's growth. Another application is to install the lamps on the top of the plant. The distance between the plants and the lamps may be several meters. The lamps may have much higher power than when the lamps were close to the plants and the lamps may cover more space.

Control system 105 may be connected to the sensor system 108 and the conditioning system for controlling the conditioning system according to information from the sensor system 108 and a condition formula that is one or both of developed with the terminal 109 or received from the data exchange and communication center 107. The plant growing instructions are quantified and stored as an electronic file, which is called the formula. Each formula may correspond to one type of plant. The formula data may include all the plant's growing condition requirements from the seeding to the harvest, including the growing period, humidity, light intensity, watering, fertilizing, etc. The formula may be achieved from other terminal users or it may be selected from a plurality of condition formulas stored on the data exchange and communication center 107 and downloaded from the data exchange and communication center 107, and then imported into the terminal system 109. The downloaded condition formula may be updated at the control system 105, and the updated formula uploaded to the center 107. The controller 105 may control the plant growing system based upon the formula and the information collected by the sensor system 108. A formula may include growing condition requirements that change with time. In an embodiment, a formula may include condition requirements that continuously or discontinuously change according to a fixed schedule. In another embodiment, a formula may comprise plural instructive portions each being for one or more stages of plant growth. The system may transition between stages for example according to a fixed schedule, according to user intervention, or according to detected plant growth. The information collected by the sensor system 108 may include one or more of light color, light intensity, control system action, sensor measurement, environment conditions, fertilization adjustment, analysis results done by the control system, date and time, equipment, organization, information associated with plant growth, and identification of the terminal The formula may be adjusted by control system 105 based on various factors such as elevation or soil type.

The sensor system 108 may include, but is not limited to, a CO2 sensor, humidity sensor, a color sensor, a light intensity sensor, and a temperature sensor. These sensors may be installed around the plant's growing space, such as a green house or a growing chamber, depending upon the sensor types. For example, the light intensity sensor may be installed right beside the plant to get an accurate measurement of the light received by the plant and the soil humidity sensor may be installed in the soil at different locations of the plant's growth space. The sensor system 108 may also include a digital camera for obtaining visual images of the plant. These sensors may collect the plant's growing status and the ambient conditions regularly. This data may then be sent to the controller 105 for processing. The controller and the data storage and date sharing systems 105 may be implemented in many different ways. This system may be computer-based or be a microprocessor based system. The controller 105 analyzes the data collected by the various sensors and then controls the conditioning subsystems 101, 102, 103 and 104 according to the analysis result. For example, the light intensity sensor sends the collected data to the controller 105; the controller 105 compares this to the corresponding light intensity requirement in the formula; if the collected intensity is lower than the required intensity that is set in the formula the controller 105 will adjust the lighting system 101 and turn the light brighter and vice versa. The information collected by the sensor system 108 may be made available to one or more users via the data exchange and communication center 107.

The controller 105 also may control the conditioning subsystem 101, 102, 103 and 104 according to the preset data. Normally the system runs automatically according to the formula, but when the user controls some systems manually, the user may override the pre-set value in the system. For example when the plant needs more light, the user may turn up the light and hold this intensity until the user releases the setup. The users may enter the data with a user interface, for example displayed on a touch screen, using a user input device such as a keyboard and a mouse. The user interface provides the user with a way to enter or modify the formula information manually, to communicate with other terminals 109 and the data exchange and communication center 107. The user interface may be installed on a standard computer or consumer electronics device such as a smartphone. The computer or consumer electronics device may communicate with a terminal 109 directly by electronic means such as over the internet 106 or may communicate with the data exchange and communication center 107, which communicates with a terminal 109. From the interface, the user may import a formula from other users or export a formula to share with other users. A formula may comprise a number of parameters. Different formulas may, in an embodiment, differ primarily or solely in the values of the parameters. In this embodiment the interface may have entries to set up a value of each parameter in the formula, so the user may modify an imported formula or create their own formula.

The storage system 105 may record the plant's growing information that has been collected by the sensor systems 108 and store this data. In an embodiment, the terminal 109 may transmit data or a subset of the data in addition to or instead of storing the data.

The terminal 109 connects to the data exchange and communication center 107 through a network 106. The data sharing system 105 may include media ports such as a USB or CD to import the data locally.

The controller, the data storage system, and the data sharing system (all identified by reference numeral 105 in FIG. 1) may be integrated as a combined unit or assembled as co-operating stand-alone units.

The system may include the data exchange and communication center 107. The control system 105 is connected to receive the condition formula from the data exchange and communication center 107, and send the condition formula and information from the sensor system 108 to the data exchange and communication center 105. This center 107 may store all or a portion of the data related to the plant's growth including, but not limited to environmental information, plant growing information, and the results of analys(es) carried out by the controller 105 of each terminal 109. All of these terminals 109 may be connected to this center 107. The terminals 109 may download the data for specific plants to control their conditioning subsystems 101, 102, 103 and 104 accordingly. Also, the terminal 109 may upload the plant's growth data to the center 107 for sharing. The center may be implemented with a computer server system. This server may also be open to the public. Thus, the data exchange and communication center 107 may be accessible by the public through one or more telecommunication networks 106. People may access the information on the server through one or more devices, such as a personal computer or a cell phone, instead of the terminals 109. Part or all of the information on the server may be classified and may only be accessed by people with the authorization to do so. One of the embodiments of the server is a web application system. The users of the terminals 109 have the account to log on to the server using a browser. The public users may also browse the authorized web pages just like normal internet surfing. The data on the server is stored and managed in a database system. Through the system the users may download and upload data just like normal internet operations. The data exchange and communication center 107 may be configured to allow users to upload formulas to the data exchange and communication center 107 and to make the uploaded formulas available to particular users or to the general public. The data exchange and communication center 107 may be configured to allow a user to download a formula from the data exchange and communication center 107. The data exchange and communication center 107 may be configured to allow the user to order the data exchange and communication center 107 to send a formula directly to a terminal 109. The data exchange and communication center 107 may be configured to allow a user providing an uploaded formula to also provide additional information to be presented in association with the uploaded formula, such as for example text, pictures, or other media. The data exchange and communication center 107 may be configured to allow other users to also provide additional information to be presented in association with an uploaded formula.

The terminal 109 of the plant growth system includes a conditioning system, for example having one or more conditioning subsystems 101, 102, 103 and 104. These conditioning subsystems 101, 102, 103 and 104 control the growing plant's environmental conditions such as the humidity, temperature, fertilization, and the growing body (soil, growing solution) etc. These conditioning subsystems 101, 102, 103 and 104 are controlled by the controller 105 via either wired or wireless methods. In general the terminal 109 may be locally or remotely accessible by a terminal user through one or more of a wired connection, a wireless connection, or one or more telecommunication networks 106.

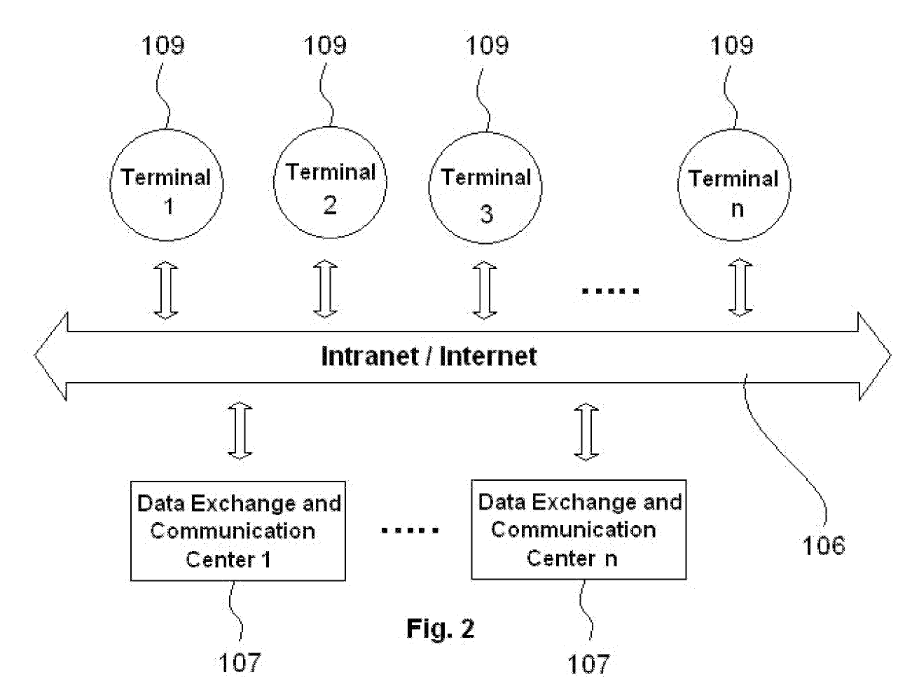

FIG. 2 shows a network with plural terminals 109 and data exchange and communication centers 107. All of these terminals 109 and data exchange and communication centers 107 may connect to the network 106. Each terminal 109 may communicate with one or more specific terminals 109 directly in a point-to-point method or through the centralized data exchange and communication center 107. The terminal 109 may communicate with one or plural data exchange and communication centers 107. The data exchange and communication centers 107 may communicate with each other via the network 106. Although the terminals 109 may connect to the network 106, these same terminals 109 may still work by for example growing plants or collecting data independently without a network 106.

There is no requirement that the terminal 109 be always connected to receive and send to the center 107 or other terminals 109. For example, data may be sent/received continuously, periodically, or on an ad hoc basis, both automatically or manually as is desired by a terminal user.

Information such as the condition formula, and plant growth information may be stored in a persistent computer memory. The persistent computer memory may be associated with a specific server or may be a shared resource. The information in the persistent computer memory is a physical record comprising a mechanical, electrical, magnetic, electro-magnetic, optical or quantum mechanical element in a specific state. Each reference to sending or receiving is a reference to a message sent over conventional telecommunication channels, including electrical, electromagnetic and optical channels.

The word controller and control system are used interchangeably throughout.

Immaterial modifications may be made to the embodiments described here without departing from what is covered by the claims.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A plant growth system having a terminal comprising:
a zone for growing a plant;
a sensor system in the zone connected to detect one or more conditions in the zone;
a conditioning system in the zone connected to alter one or more conditions in the zone;
a control system connected to the sensor system and the conditioning system for controlling the conditioning system according to information from the sensor system and a condition formula that is one or both of developed with the terminal or received from a data exchange and communication center;
the control system being connected to receive the condition formula from the data exchange and communication center, and send the condition formula and information from the sensor system to the data exchange and communication center.

2. The plant growth system of claim 1 in which the conditioning system further comprises an LED lighting system that includes LEDs and is adjustable in color and intensity.

3. The plant growth system of claim 2 in which the LEDs are configured to produce one or both of visible and invisible light.

4. The plant growth system of claim 2 in which the LED lighting system is configured to produce one or both of single or mixed colors.

5. The plant growth system of claim 1 in which the conditioning system further comprises one or more of a dimmable or non-dimmable metal halide light, a high pressure sodium light, a low pressure sodium light, a fluorescent light, an incandescent light, and a plasma light with single or mixed colors.

6. The plant growth system of claim 1 in which the control system is programmable and includes a data storage system.

7. The plant growth system of claim 1 in which the one or more conditions alterable by the condition system comprise one or more of light intensity, light color, lighting time period, humidity, temperature, CO₂ concentration, and fertilization.

8. The plant growth system of claim 1 in which a plurality of terminals are connected through one or more telecommunication networks to the data exchange and communication center.

9. The plant growth system of claim 8 in which the terminal is connected to communicate with other terminals of the plurality of terminals through the data exchange and communication center or through one or more telecommunication networks by a point to point method.

10. The plant growth system of claim 1 in which the control system is connected to selectively receive the condition formula from a plurality of condition formulas stored with the data exchange and communication center.

11. The plant growth system of claim 1 in which the data exchange and communication center is accessible by the public through one or more telecommunication networks.

12. The plant growth system of claim 1 in which the information includes one or more of light color, light intensity, control system action, sensor measurement, environment conditions, fertilization adjustment, analysis results done by the control system, date and time, equipment, organization, information associated with plant growth, and identification of the terminal.

13. The plant growth system of claim 1 in which the terminal is locally or remotely accessible by a terminal user through one or more of a wired connection, a wireless connection, or one or more telecommunication networks.

14. The plant growth system of claim 1 in which the control system further comprises a touch screen user interface.

15. The plant growth system of claim 1 in which the sensor system further comprises one or more cameras to monitor plant growth.

16. The plant growth system of claim 1 in which the zone comprises one or more of a chamber, a cabinet, a shelf, a shelter, a house, a building, an underground haven, a soil growing medium, a non soil growing medium, an aquarium, and a greenhouse.

17. The plant growth system of claim 1 applied as a mini-plant growing system.

18. The plant growth system of claim 1 applied in private, commercial, or industrial plant growth.

19. The plant growth system of claim 1 further comprising the data exchange and communication center.

20. The plant growth system of claim 19 in which the data exchange and communication center comprises two or more data exchange and communication centers.

21. The plant growth system of claim 1 in which the terminal has a USB port to input and output data.

22. The plant growth system of claim 1 in which the terminal further comprises one or more power sources.

23. The plant growth system of claim 22 in which the one or more power sources further comprises one or more of a wall plug, or electrical power generated from coal, fuel, hydro, wind turbine, tidal power, or a solar panel.
